(19) United States
(12) Patent Application Publication
(10) Pub. No.: US 2016/0173930 A1
(43) Pub. Date: Jun. 16, 2016

(54) DEVICES AND METHODS FOR AUTOMATIC CONFIGURATION

(71) Applicants: Hisense USA Corp., Suwanee, GA (US); Hisense Electric Co., Ltd., Qingdao (CN); Hisense International Co., Ltd., Qingdao (CN)

(72) Inventor: He Jin, Duluth, GA (US)

(73) Assignees: Hisense USA Corp., Suwanee, GA (US); Hisense Electric Co., Ltd., Qingdao (CN); Hisense International Co., Ltd., Qingdao (CN)

(21) Appl. No.: 14/572,640

(22) Filed: Dec. 16, 2014

(51) Int. Cl. H04N 21/431; H04N 21/414; H04N 21/45; H04N 21/488; H04N 21/466; H04N 21/475; H04N 21/482; H04N 21/41; H04N 21/433

(52) U.S. Cl. CPC H04N 21/431; H04N 21/4126; H04N 21/41407; H04N 21/4316; H04N 21/4532; H04N 21/4334; H04N 21/4668; H04N 21/4755; H04N 21/4826; H04N 21/4882

(57) ABSTRACT

Devices and methods for automatic configuration are provided. The device includes a processor, a non-transitory storage accessible to the processor, and a display at least partially controlled by the processor. The device is configured to receive a signal from a terminal device, where the signal includes information indicative of a user preference of the terminal device. The device is configured to update a setup at least partially based on the user preference of the terminal device and display a user interface on the display at least partially based on the setup.

### BACKGROUND

Currently, smartphones are becoming more and more popular. People travel with their smartphones all the time. Smartphones typically include the features of a phone with those of another popular consumer device, such as a personal digital assistant, a media player, a digital camera, and/or a GPS navigation unit. Smartphones may also include additional features of a touchscreen computer, including web browsing, Wi-Fi, 3rd-party apps, motion sensor, mobile payment and 3G.

Similarly, smart TVs and other smart appliances are becoming more and more popular. A smart TV is a television set or set-top box with integrated Internet and Web 2.0 features, and is an example of technological convergence between computers and television sets and set-top boxes. Besides the traditional functions of television sets and set-top boxes provided through traditional broadcasting media, these devices may also provide online interactive media, Internet TV, over-the-top content, as well as on-demand streaming media, and home networking access.

### SUMMARY

In an aspect, one or more embodiments of this disclosure disclose a device for automatic configuration. The device includes a processor, a non-transitory storage accessible to the processor, and a display at least partially controlled by the processor. The device is configured to: receive a signal from a terminal device, the signal including information indicative of a user preference of the terminal device; obtain a setup at least partially related to the user preference of the terminal device; and display a user interface on the display at least partially based on the setup.

In another aspect, one or more embodiments of this disclosure disclose a method implemented in a device including a processor. In the method, the device receives a signal from a terminal device via a wireless connection between the device and the terminal device, where the signal includes a user preference of the terminal device. The device updates a setup related to the user preference of the terminal device. The device displays a user interface on a display of the device at least partially based on the user preference.

In yet another aspect, one or more embodiments of this disclosure disclose a system including a television. The television is configured to perform acts including: receiving a signal for media from a smartphone via a wireless connection between the television and the terminal device, the signal comprising a user preference of the smartphone; updating a setup related to the user preference of the smartphone; and displaying a user interface on the television device at least partially based on the user preference.

### BRIEF DESCRIPTION OF THE DRAWINGS

FIG. 1 is a block diagram of an example environment in which a system according to one or more embodiments of the disclosure may operate;

FIG. 2 illustrates an example device in the system for automatic configuration;

FIG. 3 illustrates an example management device for automatic configuration;

FIG. 4 is an example block diagram illustrating embodiments of the disclosure;

FIG. 5 is another example block diagram illustrating embodiments of the disclosure;

FIG. 6 is a diagram illustrating embodiments of the disclosure; and

FIG. 7 is an example flowchart illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. section 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

The term “user” is used to describe one or more operators of a device. The “user” may include a human user or a machine that operates or uses the device.

FIG. 1 is a block diagram of an example environment in which a system according to one or more embodiments of the disclosure may operate. The media display system 100 may include a network system 150 connected to a media display device 110, a management device 120, and a terminal device 130. The network system 150 may include a local area network, a home network, a WiFi network, an Internet, a mobile network, or any other communication network that may be used to connect two or more devices. The media display device 110 may be a TV, a smart TV, or other display devices that include a display unit. The management device 120 may be a computer, a server computer, a laptop, or any other computing devices that includes a processor and a display unit. The terminal device 130 may include one of: a phone, a smartphone, a media player, a smart watch, or any other devices that may be configured to interact with people and other terminal devices.

The network system 150 may include a wireless network at a residential home or a local network in a business building. In either case, the media display device 110 may communicate with the management device 120 and the terminal device 130 via the network system. For example, in a residential home, the media display device 110 may be a smart TV that may communicate with a computer and a smartphone connected to the same home network. The media display device 110 may be configured to communicate with a terminal device 130 via a direct communication link such as a Bluetooth connection, near field communication (NFC), or other types of short-range wireless communication.

The management device 120 may record user information and user preferences when the user checks in at the front desk. The management device 120 may then send the user information and user preferences to the media display device 110. The media display device 110 may then update the setup based on the user information and user preferences. Thus, in a hotel, the media display device 110 may be controlled by the management device 120 or the terminal device 130. The management device 120 may have a higher priority than the terminal device 130. For example, the management device 120 may set the smart TV in a hotel room to show kids programs only. The hotel guest may not change or remove the preferences of “kids programs only” using the smartphone.

Similarly, in a hotel, the media display device 110 may be a smart TV in a hotel room or an information TV in the hall. The media display device 110 in a hotel may communicate with a management device such as a computer terminal at the reception desk in the hotel or a computer server in the hotel. The media display device 110 may also communicate with hotels guests' smartphones, smart watches, or other smart devices via a short-range wireless communication.

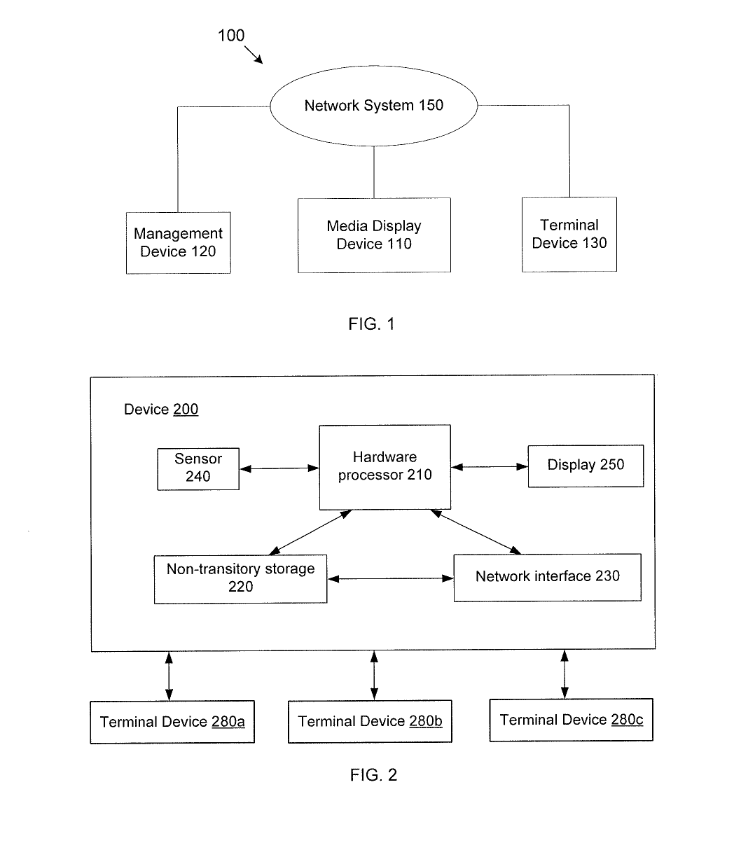

FIG. 2 illustrates an example device in the system for automatic configuration. The example device 200 may be implemented in a media display device including a hardware processor 210, a non-transitory storage medium 220, and a network interface 230. Or, for example, the example device 200 may be a smart TV that includes the non-transitory storage medium 220 that is configured to store channel information, display preferences, language preferences, and other types of information. The non-transitory storage 220 may be configured to store texts in a plurality of preset languages to be displayed in a user interface, where the plurality of preset languages include at least one of: English, Chinese, Spanish, French, Russian, Japanese, Korean, and German. The example device 200 may also include a TV tuner configured to receive TV signals. The TV tuner may be configurable to receive TV signals in a preferred language of a user preference.

The example device 200 may be configured to provide automatic configuration in a public or private network. The hardware processor 210 accesses the programs and data stored in the non-transitory storage medium 220. The example device 200 may further include at least a sensor 240, at least one display screen 250, circuits, and other electronic components. The display screen 250 may be configured to display welcome messages, commercial programs, movies, or TV programs. The example device 200 may communicate with other terminal devices 280a, 280b, and 280c via the network interface 230. The example device 200 may display user interfaces on the display screen 250. The example device 200 may be configured to display a user interface at least partially based on the user preference. The user interface may include at least one of the following: a welcome message, a program list, a commercial program, a movie list, a media list, a text window, a program recommendation, a TV program, or any information related to the user preference.

The example device 200 may have more hardware components or less hardware components than the example configuration shown in FIG. 2. The example device 200 may also be implemented in other hardware configurations.

For example, the example device 200 may be a smart TV configured to display a user interface and other media contents. The example device 200 is configured to receive a signal from a terminal device, where the signal includes information indicative of a user preference of the terminal device. The example device 200 may automatically pair with terminal device when a distance between the example device 200 and the terminal device is smaller than a preset threshold, or the example device 200 and the terminal device are in the same network. The user preference of the terminal device may include at least one of the following: a preferred language, a media list, a video list, a preferred web browser, a preferred TV channel, a preferred movie theater, and any user defined preferences. The example device 200 may also receive other information from the terminal device. The other user information may include: user age, user interests, user accounts and passwords, user schedule, user calendar, and any other information that the user agree to share with the example device 200. The device 200 may then display a user interface of the device at least partially based on the setup. For instance, the example device 200 may obtain a language setup related to the preferred language of the terminal device and displays a message at least partially in the preferred language on the user interface of the example device 200.

For instance, in a hotel room, a guest may first register at the front desk and provide the phone number or other user identification to a receptionist at the front desk. The receptionist may then input the phone number and other user identification in a management device. When the guest enters the guest room, a smart TV at the guest room may automatically recognize the guest using the phone number or other user identification related to a smartphone.

The smart TV may then automatically communicate with the smartphone and obtain user configurations on the smartphone, which may include at least one of the following: a preferred language of the smartphone user, media preferences of the smartphone user, or any other user configuration the smartphone user agreed to share with the smart TV. The media preferences of the smartphone user may include: a preferred movie list of the smartphone user, a preferred TV program list of the smartphone user, a preferred music list of the smartphone user, a preferred book list of the smartphone user. The smart TV may then display a welcome message using the preferred language. The welcome message may include the name of the smartphone user in the preferred language. Along the welcome message, the smart TV may display recommended programs based on the media preferences obtained from the smartphone.

The guest may indicate that he/she has a kid with him at the front desk. In that case, the smart TV may automatically recommend TV programs for kids when the guest turns on the smart TV.

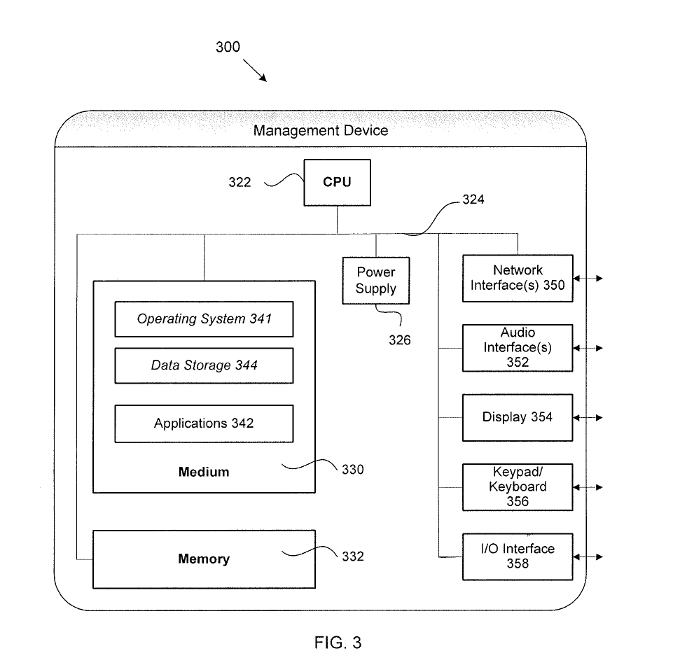

FIG. 3 illustrates an example management device 300 for automatic configuration. The management device 300 may include different hardware configurations or capabilities. For example, a management device 300 may include one or more central processing units 322, memory 332 that is accessible to the one or more central processing units 322, one or more medium 330 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A management device 300 may also include one or more operating systems 341, such as Windows Server, Mac OS X, Unix, Linux, FreeBSD, or the like. Thus, a management device 300 may include, as examples, dedicated rack-mounted servers, desktop computers, laptop computers, set top boxes, integrated devices combining various features, such as two or more features of the foregoing devices, or the like.

The management device 300 in FIG. 3 may serve as a management device 120 shown in FIG. 1. The management device 300 may also serve as a computer server that implements at least part of the computer system for automatic configuration. The management device 300 may communicate with a media display device and a plurality of terminal devices via an Internet network or a short-range wireless communication.

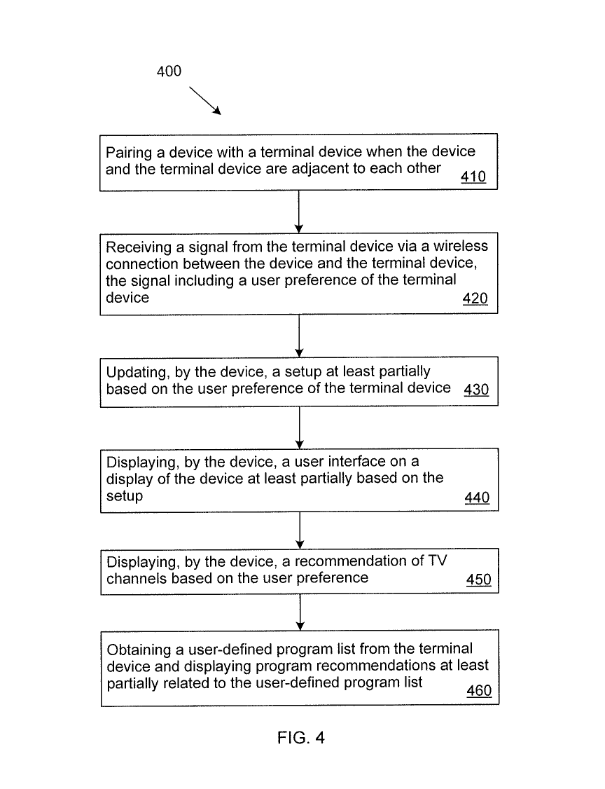

FIG. 4 is an example block diagram illustrating one or more embodiments of the disclosure. The example method 400 may be implemented using the system and devices described above. For example, the method 400 may be partially implemented by a smart TV.

In act 410, the device pairs with a terminal device when the device and the terminal device are adjacent to each other. The pair process may be imitated by the device or the terminal device. The device pair with the terminal device when a distance between the device and the terminal device is shorter than a preset threshold value or when the device and the terminal device are in the same network. For example, the device, e.g. a smart TV, may pair with a smartphone when a guest enters the hotel room. Further, the smart TV may send a pairing request to the smartphone via a wireless communication network. In another example, an information TV in a hotel hall may be configured to display conference schedule, map, and/or promotions to all guests in the hotel. The information TV may pair with a terminal device of any guest registered at the hotel. Alternatively, a smart TV may pair with a terminal device in the same local area network which is connected to the same wireless router as the smart TV.

In act 420, the device receives a signal from a terminal device via a wireless connection between the device and the terminal device, where the signal includes a user preference of the terminal device. The user preference of the terminal device may include at least one of the following: a preferred language, a media list, a video list, a preferred web browser, a preferred TV channel, a preferred movie theater, and any user defined preferences. The device may receive a pairing request from the terminal device when a distance between the device and the terminal device is shorter than a preset threshold value. For example, when any guest stands in front of the information TV within a preset distance for a predefined period of time, the information TV may pair with a terminal device of the guest to obtain user preferences and adjust its display content based on the user preferences. The preset distance may be adjusted according to specific hotels. For example, the preset distance may be set as: four feet, three feet, or any other reasonable distance. The predefined period of time may be set as: 10 seconds, 5 seconds, or other short time period.

In act 430, the device obtains information indicative of a user preference. The user preference may include a language setup related to a preferred language of the terminal device or other devices. The user preference may further include favorite programs of the user, user information, and individualized setup. If the device has not been set up yet, the device may obtain a setup based on the user preference locally from its non-transitory storage medium. Alternatively or additionally, the device may obtain the setup from a remote server or database. If there is an existing setup stored in the device, the device may obtain a new setup based on the existing setup by updating the existing setup according to the user preference. The existing setup may include a default set, a previous setup, or a hotel setup. The setup may include language setup, program setup, channel setup, favorites setup, and etc. For example, the non-transitory storage of a smart TV is configured to store texts in a plurality of preset languages to be displayed in the user interface, the plurality of preset languages comprising at least one of: English, Chinese, Spanish, French, Russian, Japanese, Korean, and German. If a foreign language is not stored in the non-transitory storage, the smart TV may download the texts in the foreign language from a remote server or database.

In act 440, the device may display a user interface on the device at least partially based on the setup. The user interface may include at least one of the following: a message, a program recommendation, a TV program, a movie, a channel guide, a webpage, or any other information that the user may be interested in based on the user preference. For example, the device displays a message at least partially in the preferred language on the user interface of the device. The message may be a welcome message. The message may include a question whether the smartphone user would like to request the smart TV to change its language setup. For example, in a hotel guest room, the smart TV may display the welcome message to the smartphone user in a preferred language of the smartphone user. In a hotel hall, the information TV may display all its content or at least part of its content in the preferred language of the smartphone user (i.e. the guest in front of the information TV).

In act 450, the device may display a recommendation of TV channels based on the language setup. For example, a smartphone user may have a preferred language of Chinese in the smartphone. When the smartphone is paired with a smart TV, the smart TV may recommend TV channels that are broadcasted in Chinese to the smartphone user. The smart TV may recommend other programs based on media preferences of the smartphone user.

In act 460, the device may obtain a user-defined program list from the terminal device and display program recommendations at least partially related to the user-defined program list. The user-defined program list may include at least one of the following: a preferred movie list, a preferred TV program list, a preferred music list, and a preferred book list. The device may then select movies, TV programs, music channels, or audio books which are related to the user-defined program list and display the selections as recommendations to the user.

The acts in FIG. 4 may be implemented using different program modules in a device illustrated in FIG. 2 or FIG. 3. The acts in FIG. 4 may be implemented using a hardware processor or a combination of software and hardware.

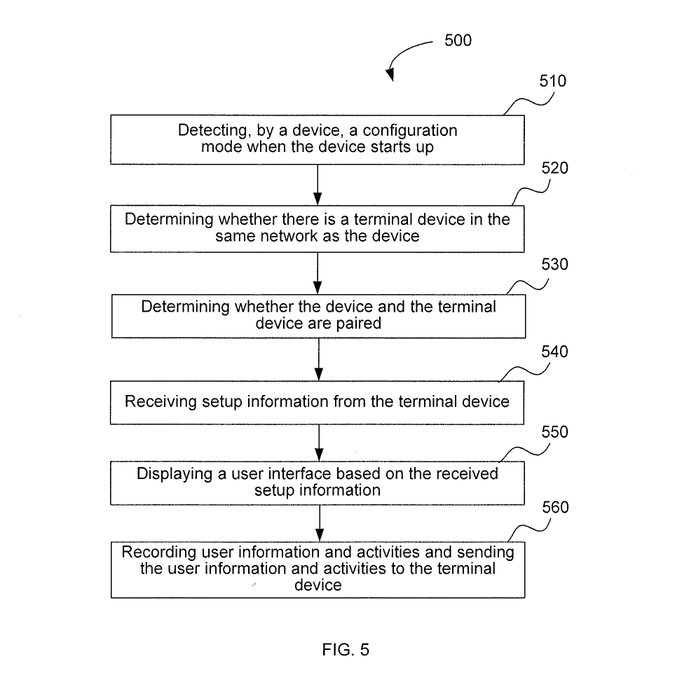

FIG. 5 is another example block diagram illustrating one or more embodiments of the disclosure. The method 500 may be implemented by a device such as a smart TV. In act 510, the device detects a configuration mode when the device starts up. For example, a smart TV may detect its configuration mode when it is turned on. The smart TV may have one or more configuration modes stored in a non-transitory storage medium accessible to a processor of the smart TV. The configuration modes may include at least one of the following: a default manufacture mode, a user-defined mode, a hotel-defined mode, or any other preset modes.

In act 520, the device determines whether there is a new terminal device in the same network as the device. The device may communicate with a router or gateway to determine whether there is a new smartphone connected to the same local area network. For example, a smart TV may need to be connected to a home network in an initial setup after a user bought the smart TV. The smart TV may determine whether there is other terminal devices connected to the same home network and the device may import the user preferences from the other terminal devices during its initial setup.

In act 530, the device may determine whether the device and terminal device are paired. For example, the smart TV may determine whether the smart TV and the smartphone are paired via a wireless communication network. The smart TV may also determine whether the smart TV and the smartphone are paired via a direct communication link such as a Bluetooth connection, NFC, or other types of short-range wireless communication.

In act 540, the device receives setup information from the terminal device automatically after they are paired. The device may automatically search the terminal device and request the terminal device to send the information to be synced between the device and the terminal device. Additionally or alternatively, the device may automatically identify and extract user information from the terminal device. The device may sync all the information in a background process and the user information details may not be disclosed on the screen of the device. The terminal device may be configured to display a message requesting the user of the terminal device to confirm the automatic transmission of the setup information. The setup information may include a language preference of the terminal device, the time zone of the terminal device, the preferred media list of the terminal device, and other setup information of the terminal device. The setup information may include other user preferences of the terminal device. To protect user privacy, the device may include a privacy setting which may be adjusted by the user directly or adjusted based on the setup information. The privacy setting may include at least three settings: automatically removing all historical data after being turned off, automatically removing all historical data after a preset time period, and only removing historical data manually through the user interface.

Additionally or alternatively, the setup information may include a setup for a similar device at an earlier time. For example, a hotel guest may have a smartphone that stores the setup information for a TV at home. When the hotel guest stays in a hotel room, the hotel TV may automatically obtain the setup information from the smartphone and use the setup information to configure the hotel TV. Similarly, a hotel guest may have a smartphone that stores the setup information for a TV at a different hotel in an earlier trip. The smartphone may remember any user input and any setup change made on one TV so that the smartphone may update setup on other TVs.

In act 550, the device displays a user interface based on the setup information. The user interface may include a message in a preferred language according to the language preference of the terminal device. The user interface may include subtitles in the preferred language. The user interface may also include channel information or other contents displayed in the preferred language.

In act 560, the device records user information and activities and sends the user information and activities to the terminal device. The user information may be input from the user via the terminal device or from the management device. The user activities may include user shopping activities, user viewing activities, or other user activities the user performed on the TV. When receiving the user information and activities, the terminal device may update the user preference on the terminal device based on the user information and activities. For example, the user may started watching a new movie or other programs in the hotel but does not finish the whole move or programs. The TV may record the viewing progress of the new movie or other programs and send the progress back to the terminal device when the user check out or leaves the hotel room. When the user get back home or arrives at a different hotel, the user may use the terminal device to sync the viewing progress about the new movie or other programs.

For each terminal device, the acts in 510-560 may be repeated so that the device such as a smart TV may display individualized user interface according to different user preferences without user input.

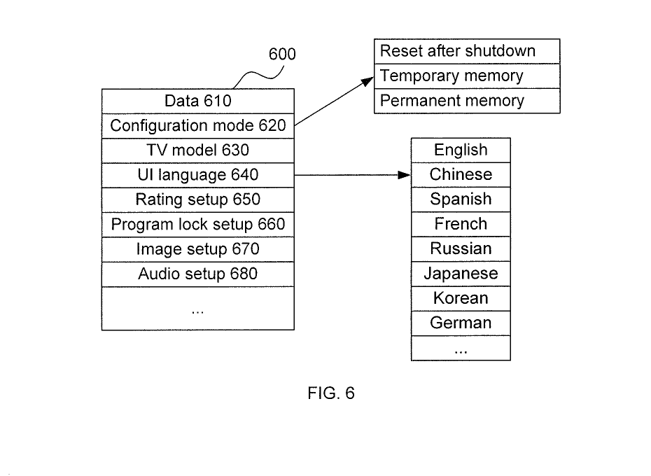

FIG. 6 is a diagram illustrating embodiments of the disclosure. The diagram illustrates an example of part of TV configurations in a TV memory storage 600 of a TV according to embodiments of the disclosure. The TV memory storage 600 may include TV configurations that include data 610, configuration modes 620, TV model 630, user interface (UI) language 640, rating setup 650, program lock setup 660, image setup 670, audio setup 680, and etc. The configuration modes 620 may include at least three modes: reset after shutdown, temporary memory, and permanent memory.

In the “reset after shut down” mode, the TV may adopt the updated setup and reset to a default setup shutdown. This mode may be preferred by hotel owners or other service providers in public areas. In the “temporary memory” mode, the TV may adopt the updated setup for a preset period of time and reset to a default setup after the preset period of time. The preset period of time may be set by a management device. For example, the hotel management server may set the TV to be reset to a default hotel setup according to the checkout time of the hotel guest. In the “permanent memory” mode, the TV may adopt the updated setup until the user changes it using the terminal device or other controls. This configuration mode may be preferred by home owners for their private TV at home.

The UI language 640 may include a plurality of preset texts in different languages to be displayed in the user interface. The different languages may include at least one of: English, Chinese, Spanish, French, Russian, Japanese, Korean, and German.

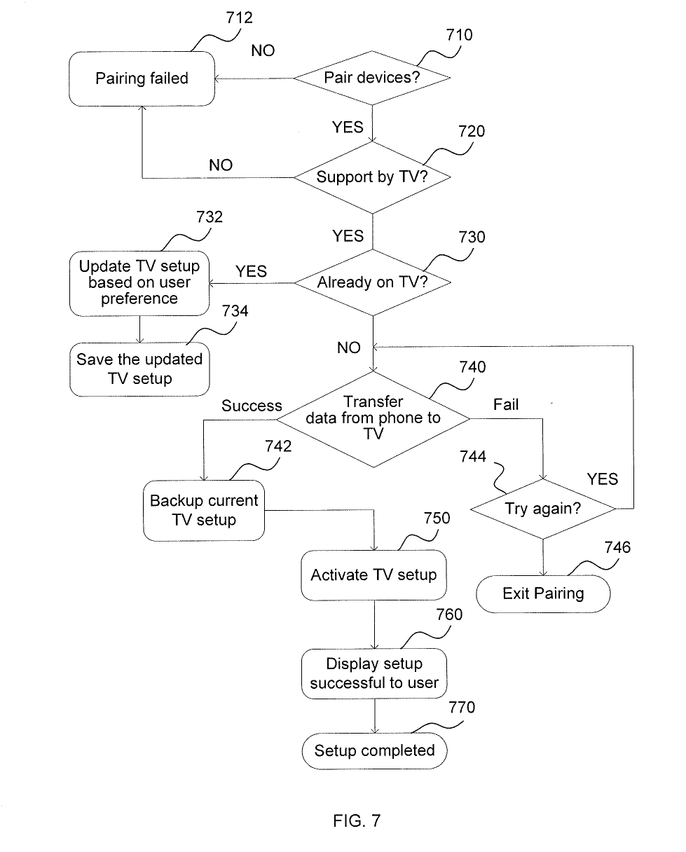

FIG. 7 is an example flowchart illustrating embodiments of the disclosure. The flowchart illustrates the pairing and setup process between a smart TV and a smartphone according to embodiments of the disclosure.

In act 710, the smartphone may request a pairing process between the smartphone and a smart TV. The request may be transmitted directly using a short-range wireless communication. The request may also be transmitted using a wireless local area network via a wireless router. The request may include user identification information stored in the terminal device. The request may further include user preferences.

In act 720, the smart TV receives the request and determines whether the smart TV supports the pairing process. If not, the smart TV may return a message to the terminal device so that the terminal device may display a paring failure message on the terminal device in act 712. Alternatively or additionally, if the terminal device does not receive a response from the smart TV for a preset period of time, the smartphone may determine that the smart TV does not support the pair process.

In act 730, the smart TV determines whether the smart TV stores the necessary data based on the user identification and/or user preferences. If the smart TV recognizes the smartphone and determines that the smart TV has at least a portion of the necessary data, the smart TV may update the current setup according to the user preference. For example, in act 732, the smart TV may change the UI language if the smart TV includes the preferred language of the user preference. The smart TV may remember the user preference based on the user identification in act 734.

In act 740, the smart TV may request additional information from the smartphone. For example, the smart TV may request the smartphone to provide user preferences including: a media list, a video list, a preferred web browser, a preferred TV channel, and a preferred movie theater. The smart TV may request other information based on user interest as well.

If the smartphone send the user preferences successfully to the smart TV, the smart TV may back up the previous user setup in the smart TV in act 742. If the smartphone fails to send the user preferences to the smart TV, the smart TV may ask the smartphone to try again in act 744. If the user chooses to try again, the method may go back to act 740 again. If the user chooses to give up trying, the pairing process may exit in act 746.

In act 750, the smart TV may activate the updated setup and display or update a user interface on the smart TV at least partially based on the updated setup. For example, the smart TV may display shopping recommendations based on user preferences. The smart TV may display other information based on user preferences. The other information may include: a welcome message, a program list, a commercial program, a movie list, a media list, a text window, a program recommendation, and a TV program.

In act 760, the smart TV may send a message to the smartphone so that the smartphone may display a message to the user. The message may include “pairing successful” or “your device is paired with the smart TV” or other messages including similar information.

The above acts in FIG. 7 are for illustration purpose only, the pairing and setup process may include additional acts if necessary. Alternatively, the pairing and setup process may include fewer acts in different environments.

It is therefore intended that the foregoing detailed description be regarded as illustrative rather than limiting, and that it be understood that it is the following claims, including all equivalents, that are intended to define the spirit and scope of this invention.

1. A device, comprising:
a processor;
a non-transitory storage accessible to the processors; and
a display at least partially controlled by the processor, wherein the device is configured to:
receive a signal from a terminal device, the signal comprising information that defines user preference information stored on the terminal device;
update a setup of the device at least partially based on the user preference information of the terminal device; and
display a user interface on the display at least partially based on the setup.

2. The device of claim 1, wherein the user preference comprises a preferred language and the device is further configured to display a message on the user interface at least partially in the preferred language.

3. The device of claim 1, wherein the user preference information specifies at least one of the following: a preferred language, a media list, a video list, a preferred web browser, a preferred TV channel, and a preferred movie theater.

4. The device of claim 1, wherein the user interface comprises at least one of the following: a welcome message, a program list, a commercial program, a movie list, a media list, a text window, a program recommendation, and a TV program.

5. The device of claim 1, wherein the device is configured to adopt the updated setup for a preset period of time and reset to a default setup after the preset period of time.

6. The device of claim 1, further configured to update the setup at least partially based on user preference information from a management device.

7. The device of claim 1, further configured to record user information and activities and send the user information and activities to the terminal device so that the terminal device updates the user preference information based on the user information and activities.

8. A method, comprising:
receiving, by a device having a processor, a signal from a terminal device via a wireless connection between the device and the terminal device, the signal comprising information that defines user preference information stored on of the terminal device;
updating, by the device, a setup of the device at least partially based on the user preference information stored on the terminal device; and
displaying, by the device, a user interface on a display of the device at least partially based on the setup.

9. The method of claim 8, wherein the user preference information comprises a preferred language and the method further comprises:
displaying, by the device, a message at least partially in the preferred language in the user interface.

10. The method of claim 8, wherein the user preference information comprises at least one of the following: a preferred language, a media list, a video list, a preferred web browser, a preferred TV channel, and a preferred movie theater.

11. The method of claim 8, wherein the user interface comprises at least one of the following: a welcome message, a program list, a commercial program, a movie list, a media list, a text window, a program recommendation, and a TV program.

12. The method of claim 8, further comprising:
adopting the updated setup for a preset period of time; and resetting to a default setup after the preset period of time.

13. The method of claim 8, further comprising:
updating the setup at least partially based on user information from a management device.

14. The method of claim 13, wherein receiving the signal for media from the terminal device comprises:
recording user information and activities; and
sending the user information and activities to the terminal device so that the terminal device updates the user preference information based on the user information and activities.

15. A system comprising a television, the television is configured to perform acts comprising:
receiving a signal for media from a smartphone via a wireless connection between the television and the smartphone, the signal comprising information that defines user preference information stored on of the smartphone;
updating a setup of the television at least partially based on the user preference of the smartphone; and
displaying a user interface on the television at least partially based on the setup.

16. The system of claim 15, wherein the television is further configured to perform acts comprising:
displaying a message at least partially in a preferred language of the user preference information;
adjusting the user interface based on the setup; and
displaying a recommendation of TV channels based on the setup.

17. The system of claim 15, wherein the user preference information comprises at least one of the following: a preferred language, a media list, a video list, a preferred web browser, a preferred TV channel, and a preferred movie theater.

18. The system of claim 15, wherein the user interface comprises at least one of the following: a welcome message, a program list, a commercial program, a movie list, a media list, a text window, a program recommendation, and a TV program; and wherein the television is further configured to obtain a user-defined program list from the smartphone and display the program recommendation at least partially related to the user-defined program list.

19. The system of claim 15, wherein the television is further configured to adopt the updated setup for a preset period of time and reset to a default setup after the preset period of time.

20. The system of claim 15, wherein the television is further configured to:
record user information and activities; and
send the user information and activities to the smartphone so that the smartphone updates the user preference information based on the user information and activities.
